(19) United States
(12) Patent Application Publication
(10) Pub. No.: US 2002/0025278 A1
(43) Pub. Date: Feb. 28, 2002

(54) Gel manipulation apparatus

(75) Inventors: N. Leigh Anderson, Washington, DC (US); Jack Goodman, Lusby, MD (US); Andrew M. McGrath, Burtonsville, MD (US)

Correspondence Address: ROYLANCE, ABRAMS, BERRO & GOODMAN, L.L.P., 1300 19TH STREET, N.W., SUITE 600, WASHINGTON,, DC, 20036, US

(73) Assignee: GEL MANIPULATION APPARATUS

(21) Appl. No.: 09/783,132

(22) Filed: Feb. 15, 2001

Related U.S. Application Data
(60) Provisional application No. 60/260,216, filed on Jan. 9, 2001.

(51) Int. Cl. B01L 3/00

(52) U.S. Cl. 422/99; 422/102

(57) ABSTRACT

An automated computer controlled apparatus includes a robotic assembly for capturing an electrophoresis gel and transferring the gel to a sequence of treatment stages. The robotic assembly has an articulated arm assembly for capturing a gel and moving the gel to a selected work station. The gels are supported by a carrier having magnetically biased clamping jaws. The robotic arm assembly is constructed to capture the carrier to manipulate the gel. The gel is suspended by the carrier in a manner to prevent tearing and stretching of the gel. The gel treating stations have tanks with surfaces to inhibit the gel from adhering to the walls of the tank. Typically, the surfaces of the walls have a plurality of channels formed by projections to allow the flow of liquid between the gel and the wall surface and reduce surface area of the wall contacting the gel. An agitating assembly reciprocates the gel in the tank to agitate the treating liquid. In one embodiment, an agitating plate moves in a reciprocating manner within the tank and is able to press the gel against a transparent wall of the tank at selected intervals so that an image of the gel can be captured at selected time intervals.

### BACKGROUND OF THE INVENTION

Isoelectric focusing (IEF) is an electrophoretic technique that is commonly used for the analysis, separation and purification of various biological materials, and particularly proteins. Since many of the complex molecules of biological interest are amphoteric in nature, they are typically amenable to IEF separation. Gel electrophoresis is a process that is commonly used for protein and DNA analysis.

The separation of macromolecules, and particularly proteins, often is carried out by two-dimensional electrophoresis separation. The two-dimensional electrophoresis separation typically involves the sequential separation by isoelectric focusing of a sample in a gel tube followed by slab gel electrophoresis. The isoelectric focusing process in the gel tube is often referred to as first dimension separation.

In the first dimension separation, an isoelectric focusing gel, such as acrylamide, is placed or polymerized in a tube. The open ends of the tube are positioned in a tank with a buffer solution at each end of the tube. One end of the tube is positioned in a bath of a buffer solution such as sodium hydroxide solution. The other end of the tube is positioned in a bath of a second buffer solution such as a phosphoric acid solution. An electric current is applied to the two buffer solutions. The current together with ampholytes incorporated into the gel composition or titratable gel monomers incorporated into the gel, provides a pH gradient through the gel along the length of the tube. The sample to be analyzed is applied to a one end of the gel in the tube and an electric current is applied to an electrode in each of the buffer solutions. The molecules in the sample migrate through the gel under the influence of the electric potential until they reach their respective isoelectric point.

Slab gel electrophoresis, often referred to as second dimension separation, utilizes an electrophoresis gel molded between two glass plates. A gel strip or cylinder in which the protein sample has been resolved by the first dimension isoelectric focusing is placed along one edge of the slab gel. The ends of the gel slab are positioned in a buffer solution and an electric current is applied to each end of the gel. The proteins are then allowed to migrate through the gel slab under an applied voltage.

Charged detergents, such as sodium dodecyl sulfate, contained in the slab gel bind to the protein molecules. The detergents tend to unfold the protein molecules into rods having a length proportional to the length of the polypeptide chain and thus proportional to the molecular weight of the polypeptide. A protein complexed with a charged detergent is highly charged, which causes the protein-detergent complex to move in an applied electric field. When the slab gel, such as a polyacrylamide gel, functions as a sieve, the movement of the longer and higher molecular weight molecules is retarded compared to the shorter, lower molecular weight molecules.

Electrophoresis separation is generally labor intensive since numerous samples are run simultaneously. Generally, the gel tubes are prepared and placed in a suitable tank of buffer solutions. The protein samples are then manually placed on the end of a gel tube. When hundreds of protein samples are prepared daily for isoelectric focusing, the manual steps significantly increase the time requirements for performing the first dimension separation.

The resolution of the separation methods are sufficient to separate at least 150 proteins from a mixture. The first dimension isoelectric focusing separation followed by the second dimension SDS electrophoresis separation can result in the resolution of as many as

### SUMMARY OF THE INVENTION

The present invention is directed to a method and apparatus for manipulating an electrophoresis gel. More particularly, the invention is directed to an automated, computer controlled robotic assembly for transferring an electrophoresis gel between various work stations for treating the gels.

Accordingly a primary aspect of the invention is to provide an automated apparatus for manipulating an electrophoresis gel and transferring the gel from a storage tank to a gel processing tank.

Another aspect of the invention is to provide an automated apparatus having a robotic arm that is controlled by a computer to selectively transfer an electrophoresis gel between work stations.

A further aspect of the invention is to provide a computer-controlled apparatus for manipulating an electrophoresis gel along three coordinates so that the gel can be moved in three dimensions.

Another aspect of the invention is provide a computer controlled robotic apparatus that is able to transfer an electrophoresis gel in a longitudinal direction, a transverse direction and a vertical direction with respect to the dimensions of the apparatus.

Still another aspect of the invention is to provide a computer controlled articulated arm that is movable on a boom, where the boom can be moved in a horizontal direction and in a vertical direction.

A further aspect of the invention is to provide an automated computer controlled apparatus having an articulated robotic arm that is able to move into a selected position and capture an electrophoresis gel attached to a carrier, transfer the gel to a selected location and release the captured gel.

Another aspect of the invention is to provide a carrier device for attaching to an electrophoresis gel where the gel can be suspended from the carrier without damaging the gel while the gel is being transferred to a selected location.

Still another aspect of the invention is to provide a clamp device that is able to capture an electrophoresis gel and suspend the gel without damaging the gel.

Another aspect of the invention is to provide a clamp device having a pair of jaws that are biased together by magnets.

A further aspect of the invention is to provide a staining tank for an electrophoresis gel where the tank has an agitating assembly that is able to agitate the gel within the tank.

Another aspect of the invention is to provide an agitating device for an electrophoresis gel staining tank where the agitating device moves the gel in a reciprocating motion in a substantially vertical direction.

Still another aspect of the invention is to provide a tank for treating an electrophoresis gel where the tank has at least one wall having a surface that resists or inhibits the gel from adhering to the wall.

A further aspect of the invention is to provide a tank for treating an electrophoresis gel where the tank includes an agitator that moves in a substantially horizontal direction to agitate the treating liquid without damaging the gel.

A further aspect of the invention is to provide an automated agitating device for an electrophoresis tank that is able to press the gel against a side wall of the tank to capture an image of the gel at selected time intervals.

The apparatus of the invention basically comprises a robotic assembly that is controlled by a computer or central processing unit to control the movement of the apparatus. The apparatus includes a robotic arm that is able to capture and manipulate an electrophoresis gel between selected processing stations. The computer is programmed to selectively transfer the gel to selected stations for a predetermined period of time. At the same time the computer records the location of the gel and the progress of the process at each stage. The robotic assembly has an articulated arm that can be moved to an infinite number of locations within the apparatus. In one embodiment of the invention the robotic assembly has a boom that can travel in a horizontal direction and in a vertical direction with respect to the plane of the assembly. At the same time the articulated arm can travel along the length of the boom to selected positions.

The apparatus is primarily directed for use with a staining tank for the sequential staining steps of an electrophoresis gel staining process. The staining tanks include an agitator for moving the gel in a vertical direction to continuously agitate the staining liquid. The gels are suspended from a rail member and rail is reciprocated in a vertical direction to agitate the liquid.

The carrier of the invention is a clamp member that is able to capture a gel along one edge so that the gel can be suspended by the clamp. The clamp is has two jaws that are held together by a magnet. Preferable, each jaw has a magnet oriented to be attracted to each other. The magnets are typically a strip of magnetic material that is attached to a gripping edge of the jaws.

The various aspects of the invention are basically attained by providing a clamp for holding and transporting an electrophoresis gel slab, where the clamp comprises a first jaw having an operating end and a gripping end, and a second jaw coupled to and being movable with respect to said first jaw. The second jaw has an operating end and gripping end. The gripping ends of the first and second jaws have a dimension to grip and support a gel slab. The gripping end of the second jaw is biased toward the gripping end of the first jaw for gripping a gel slab.

The aspects of the invention are also attained by providing a method of manipulating an electrophoresis gel slab, where the method comprises the steps of providing a clamp having a first jaw with an operating end and a gripping end, and a second jaw with an operating end and a gripping end, and where the gripping ends are biased toward each other. A gel slab having a length, a width and a side edge is positioned in the side edge between the gripping ends of the jaws and biasing the gripping ends toward the gel slab with sufficient pressure to grip the gel slab. The clamp is lifted to vertically suspending the gel slab with the gripping ends of the jaws being biased together under sufficient force to grip the side edge of the gel slab substantially without tearing the gel slab.

The aspects of the invention are further attained by providing an automated apparatus for manipulating an electrophoresis gel slab, where the apparatus comprises a robotic arm that is movable between a plurality of work stations in a first substantially horizontal direction, a second substantially horizontal direction and a vertical direction. A carrier assembly is coupled to the robotic arm to grip the gel. The carrier assembly has at least one coupling arm for removably coupling to an electrophoresis gel slab and is movable between a coupling position and an uncoupling position. A microprocessor is operatively coupled to the robotic arm and the carrier assembly for manipulating a gel slab between the work stations.

The aspects of the invention are also attained by providing a treatment container for treating an electrophoresis gel. The container comprises a side wall having an inner face and an outer face. The inner face has a plurality of spaced-apart projections extending inwardly toward an interior region of the container. The projections are spaced apart a distance to define a channel or recess between adjacent projections. The channels are dimensioned to allow a liquid to flow between the gel and the side wall of the container. The projections have an outer face with a surface area sufficient to support a gel slab and to prevent the gel slab from adhering to the side wall when the container contains a liquid.

The objects, advantages and salient features of the invention will become apparent to one skilled in the art in view of the following detailed description of the invention in conjunction with the annexed drawings which form a part of this original disclosure.

### BRIEF DESCRIPTION OF THE DRAWINGS

The following is a brief description of the drawings, in which:

FIG. 1 is a perspective view of the apparatus for manipulating and processing an electrophoresis gel in one embodiment of the invention;

FIG. 2 is a front view of the apparatus of FIG. 1;

FIG. 3 is a partial end view of the robotic assembly in one embodiment of the invention showing the boom in the raised position;

FIG. 4 is a partial end view of the robotic assembly showing the boom in the lowered position;

FIG. 5 is a partial end view showing the articulated arms in an extended position;

FIG. 6 is a partial end view of the articulated arms in a retracted position;

FIG. 7 is a partial end view showing the articulated arms in a coupling position;

FIG. 8 is a partial side view showing the articulated arms aligned with a carrier for an electrophoresis gel;

FIG. 9 is a partial side view of the articulated arms extending through the opening in the carrier of FIG. 8;

FIG. 10 is a partial side view of the articulated arms coupled to the carrier of FIG. 8;

FIG. 11 is a front view of the carrier for an electrophoresis gel in a preferred embodiment of the invention;

FIG. 12 is an end view of the carrier of FIG. 11;

FIG. 13 is an end view of the carrier of FIG. 11 showing a gel coupled to the carrier;

FIG. 14 is a partial perspective view of the jaw of the carrier showing the resilient coupling end and the non-slip surface;

FIG. 15 is a perspective view of a carrier in a second embodiment of the invention;

FIG. 16 is a perspective exploded view of the carrier of FIG. 15;

FIG. 17 is an end view of the carrier of FIG. 15;

FIG. 18 is an end view of the carrier of FIG. 15 showing the gripping ends coupled to a gel;

FIG. 19 is an end view of a carrier in a further embodiment of the invention;

FIG. 20 is an end view of the carrier of FIG. 19 showing the gripping ends coupled to a gel;

FIG. 21 is a perspective view of a carrier in another embodiment of the invention;

FIG. 22 is an end view of the carrier of FIG. 21;

FIG. 23 is a perspective view of the agitation assembly in one embodiment of the invention;

FIG. 24 is a partial side view of the agitating assembly of FIG. 23 showing the gel support in a lowered position;

FIG. 25 is a partial side view of the agitating assembly of FIG. 23 showing the gel support in a raised position;

FIG. 26 is a perspective view of the agitating assembly in another embodiment of the invention;

FIG. 27 is a perspective view of the agitating assembly of FIG. 26 showing the gel support frame in a raised position;

FIG. 28 is a partial end view in cross-section of the agitating assembly of FIG. 27;

FIG. 29 is a partial end view in cross-section of the agitating assembly of FIG. 27;

FIG. 30 is a partial side view in cross-section of a treating tank for an electrophoresis gel showing the surface of the tank;

FIG. 31 is an enlarged partial front view of the surface of the treatment tank of FIG. 30;

FIG. 32 is a partial cross-sectional end view of the surface of the treatment tank of FIG. 30;

FIG. 33 is a partial cross-sectional view of the surface of the treatment tank in a second embodiment of the invention;

FIG. 34 is a cross-sectional view of the surface of the side wall of the treatment tank in a third embodiment of the invention;

FIG. 35 is a cross-sectional end view of the side wall of the treatment tank in a fourth embodiment of the invention;

FIG. 36 is a partial perspective view of the end wall of the treatment tank in a fifth embodiment of the invention;

FIG. 37 is a partial end view in cross-section of a treatment tank for a gel having an agitating assembly where the agitator is in a retracted position;

FIG. 38 is a partial cross-sectional end view of the treatment tank of FIG. 37 showing the agitator in an extended position;

FIG. 39 is a partial cross-sectional front view of the treatment tank of FIG. 37;

FIG. 40 is a partial end view in cross-section of the tank of FIG. 37 showing the agitator pressing the gel against the side wall of the tank;

FIG. 41 is a partial end view in cross-section of a treatment tank with an agitator assembly in another embodiment of the invention; and

FIG. 42 is a schematic diagram of the computer control system of the apparatus of the invention.

### DETAILED DESCRIPTION OF THE INVENTION

The present invention is directed to an automated apparatus for transferring and manipulating a work piece between various work stations. In particular, the invention is directed to a computer controlled, automated assembly for manipulating an electrophoresis gel between various work stations.

Referring to the drawings, apparatus 10 includes a computer controlled robotic assembly 12 constructed for manipulating an electrophoresis gel 14. In the embodiments illustrated, apparatus 10 includes several tanks 16 defining various work stations for treating and processing electrophoresis gel 14 as discussed hereinafter in greater detail.

In the illustrated embodiments, robotic assembly 12 is constructed for selectively transferring a plurality of electrophoresis gels to sequential processing stages and particularly through a sequence of staining and developing steps. The automated assembly is controlled by a computer or microprocessor, which monitors the entire assembly and components of the assembly as discussed herein. The various embodiments disclosed herein generally show a single electrophoresis gel. In practice, the assembly is constructed to receive a large number of gels that are continuously carried through the processing tanks. The processed gels are finally transferred to a storage vessel for subsequent identification and analysis of the proteins and other macromolecules in the gel.

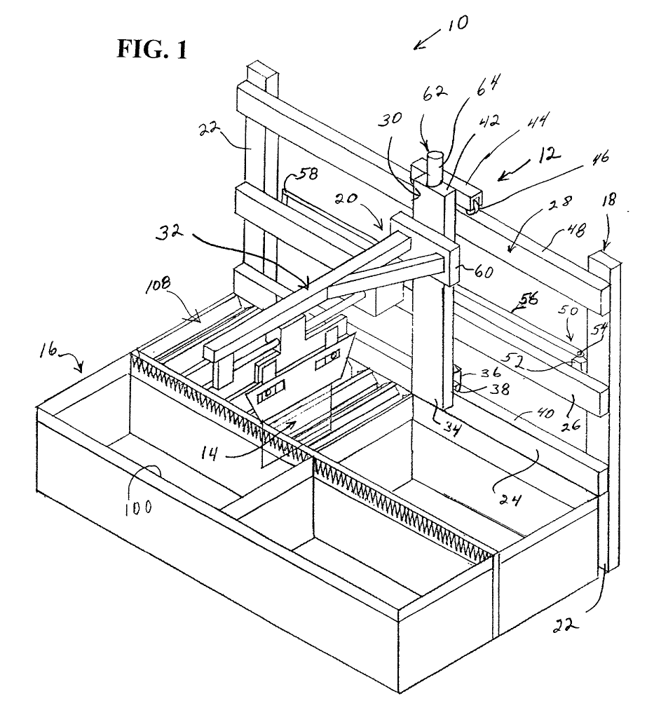

Referring to FIGS. 1-10, robotic assembly 12 includes a main support frame 18 for supporting robotic arm assembly 20. Preferably, frame 18 has a length extending substantially the entire length of apparatus 10. Frame 18 includes an upright support member 22 at each end of assembly 10. A bottom rail 24, a middle rail 26 and top rail 28 extend between vertical supports 22. In the embodiment illustrated, rails 24, 26 and 28 are oriented substantially horizontal and extend the length of assembly 10. Upright supports 22 are oriented in a substantially vertical direction.

Robotic arm assembly 20 includes a vertical rail 30 and a boom 32. Vertical rail 30 is oriented in a substantially perpendicular direction with respect to bottom rail 24 and extends between bottom rail 24 and top rail 28. Vertical rail 30 has a bottom end 34 with a bracket 36 supporting guide wheels 38. Bracket 36 and guide wheels 38 are positioned to ride along a top edge 40 of bottom rail 24. A top end 42 of vertical rail 30 also includes a bracket 44 having guide wheels 46. Guide wheels 46 and bracket 44 are positioned to ride along a top side 48 of top rail 28. Brackets 36 and 44 with guide wheels 38 and 46, respectively, effectively couple vertical rail 30 to top rail 28 and bottom rail 24. Guide wheels 38 and 46 are able to guide vertical rail 30 along the entire length of rails 24 and 28 between vertical supports 22 of frame 18. In one embodiment of the invention, top rail 28 and bottom rail 24 have a track to receive and guide wheels 46 and 38 along the respective rail.

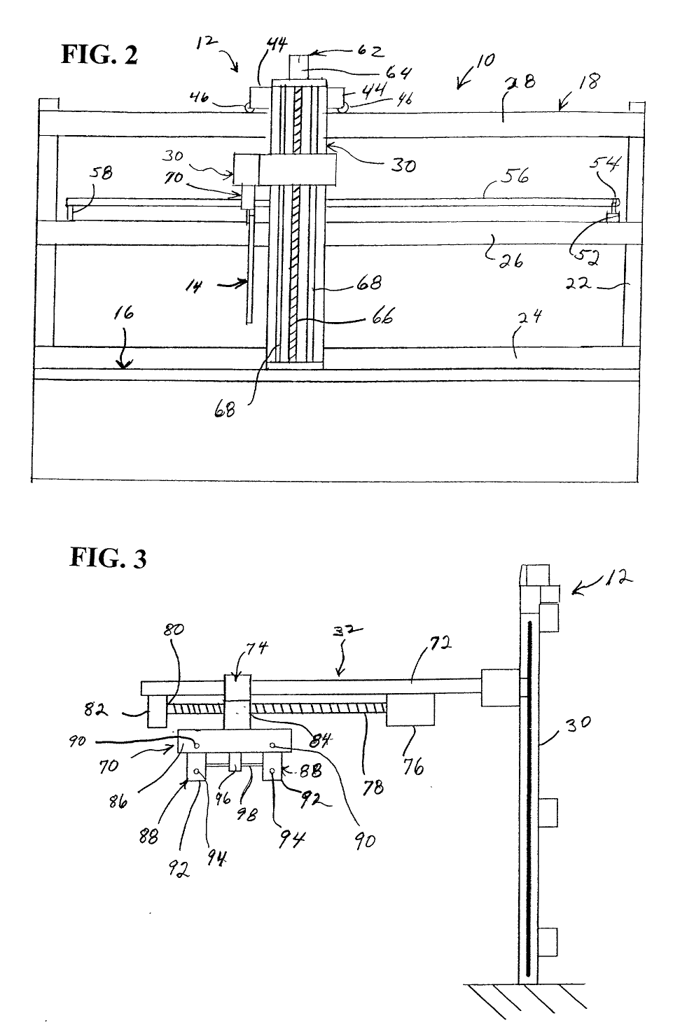

Vertical rail 30 includes a suitable drive assembly for moving vertical rail 30 along the length of frame 18. Preferably, the drive assembly is operatively connected to a controller such as a computer or microprocessor for selectively controlling the movement and position of vertical rail 30 with respect to assembly 10 as discussed hereinafter in greater detail. In the embodiment illustrated, a drive assembly 50 includes a motor 52 having a drive gear 54 coupled to the shaft of motor 52. In this embodiment, motor 52 is mounted on middle rail 26. A drive belt 56 extends between drive gear 54 and an idle gear 58. As shown in FIG. 1 and FIG. 2, motor 52 and idle gear 58 are mounted at opposite ends of frame 18 on middle rail 26. Preferably, drive belt 56 is a continuous belt that is coupled to vertical rail 30. Motor 52 is actuated to operate drive belt 56 to move vertical rail 30 along the longitudinal length of frame 18 to a selected position. Preferably, motor 52 is a reversible motor that can be controlled to move vertical rail 30 in small increments. Generally, drive belt 54 has a plurality of teeth for engaging teeth on drive gear 54 to prevent drive belt 56 from slipping. Drive belt 56 is a flexible belt having sufficient strength with limited stretching to effectively move vertical rail 30 along frame 18 between each end.

Boom 32 includes a support housing 60 coupled to vertical rail 30. Vertical rail 30 includes an operating assembly 62 for raising and lowering boom 32 along the length of vertical rail 30. Referring to FIG. 2, operating assembly 62 includes a drive motor 64 coupled to a rod 66 having external threads. A guide rod 68 is provided on each side of threaded rod 66 and extends substantially parallel to threaded rod 66. Support housing 60 of boom 32 includes a threaded member coupled to threaded rod 66 and a pair of axial passages for receiving guide rods 68. Motor 64 is operated to rotate threaded rod 66 about its axis to move housing 60 in a vertical direction along the length of threaded rod 66. Guide rods 68 are coupled to top end 42 and the bottom end of vertical rail 30 to stabilize and guide housing 60 along the length of vertical rail 30. Preferably, motor 64 is a reversible motor that can be controlled to raise and lower housing 60 and boom 32 to the desired position. Typically, threaded rod 66 and guide rods 68 extend the entire length of vertical rail 30.

In the embodiment illustrated, boom 32 is substantially horizontal and extends outwardly from housing 60. Preferably, boom 32 is substantially perpendicular to frame 18. In alternative embodiments, boom 32 can be oriented at an angle with respect to frame 18 depending on the arrangement of the work stations and the construction of the overall assembly. Boom 32 supports an articulated arm 70 that is movable along the length of boom 32.

Articulated arm 70 includes a suitable drive assembly for selectively moving articulated arm 70 along the length of boom 32. Referring to FIG. 3, in one embodiment boom 32 includes a guide rail 72 coupled to housing 60. Articulated arm 70 includes a support housing 74 having an axial passage for receiving guide rail 72. Guide rail 72 extends through the axial passage of support 74 so that support 74 and articulated arm 70 are able to slide along the length of guide rail 72.

As shown in FIG. 3, a motor 76 is coupled to guide rail 72 and includes a threaded drive rod 78 extending parallel to guide rail 72. Threaded drive rod 78 includes an outer end 80 received in a bearing 82 for supporting outer end 80 of rod 78. Bearing 82 is coupled to a distal end of guide rail 72. Support housing 74 includes an axial passage 84 having internal threads complementing the external threads on threaded drive rod 78. As shown in FIG. 3, threaded drive rod 78 extends through axial passage 84 of support housing 74. Motor 76 is actuated to rotate threaded drive rod 78 for moving support housing 74 and articulated arm 70 along the length of guide rail 72. In a preferred embodiment, motor 76 is an electric reversible motor operatively connected to a control circuit for selectively controlling the movement of articulated arm 70 in each direction along the longitudinal length of guide rail 72.

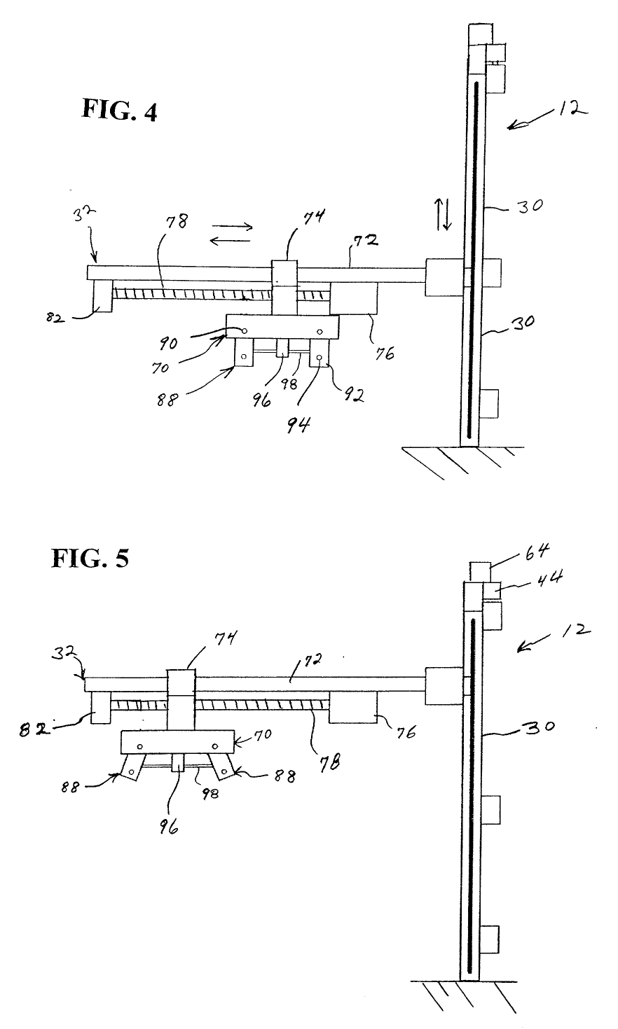

Articulated arm 70 includes a main body 86 that is coupled to support housing 74 and positioned below guide rail 72 and threaded drive rod 78. Body 86 has a longitudinal dimension oriented substantially parallel to guide rail 72 in the embodiment shown. Movable coupling arms 88 are pivotally connected to each end of body 86. Coupling arms 86 have a top end coupled to body 86 by a pivot pin 90. Coupling arms 88 have a bottom end 92 opposite the top end and include a coupling pin 94. As shown in FIG. 3, an actuator 96 is coupled to body 86 for actuating coupling arms 88. Actuator 96 is provided with connecting rods 98 coupled to each coupling arm 88 for pivoting coupling arms 88 inwardly and outwardly with respect to main body 86 from a retracted position shown in FIG. 4 to an extended position shown in FIG. 5. Actuator 96 in one embodiment of the invention is a pneumatically operated piston assembly that is capable of moving connecting rods 98 simultaneously between a retracted position and an extended position for moving coupling arms 88. In alternative embodiments, actuator 96 can be a solenoid operated device, electric motor or other device capable of actuating rods 98.

Referring to FIGS. 4-7, robotic assembly 12 is able to move and manipulate a work piece in three dimensions or coordinates. Vertical rail 30 can be actuated to move along frame 18 oriented in a longitudinal dimension of apparatus 10. Boom 32 moves in a substantially vertical direction with respect to apparatus 10 and articulated arm 70 moves in a transverse direction with respect to apparatus 10 along the length of boom 32. In this manner, articulated arm 70 can maneuver a work piece between various work stations in essentially any location of apparatus 10.

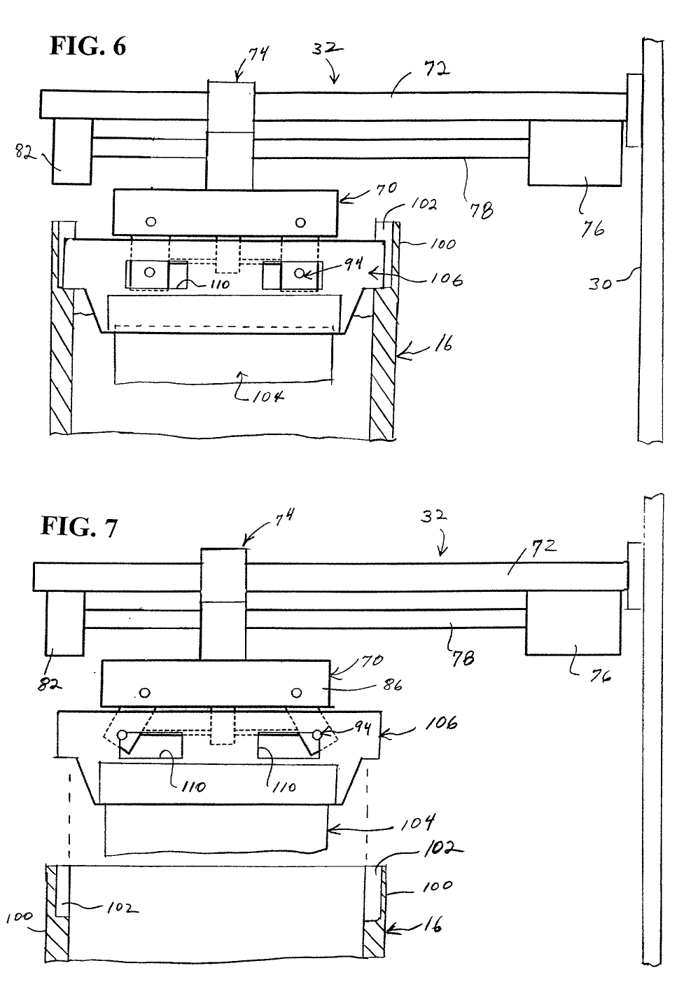

Apparatus 10 of the invention is particularly adapted for manipulating an electrophoresis gel that is obtained from a two-dimensional electrophoresis separation process as known in the art. Referring to FIGS. 6 and 7, tanks 16 are dimensioned to contain a liquid such as distilled water or a buffer solution and a plurality of electrophoresis gel slabs. Tanks 16 are formed with longitudinal side edges 100 having a plurality of spaced-apart notches 102. An electrophoresis gel slab 104 is supported by a carrier 106 as discussed hereinafter in greater detail. Carrier 106 has a length to fit within notches 102 of tank 16 so that gel 104 is suspended in the liquid contained in tank 16. Robotic assembly 12 is operated to sequentially transfer gels 104 to a staining station 108 as shown in FIG. 1. Referring to FIG. 6, carrier 106 is suspended in notches 102 of tank 16 and articulated arm 70 is lowered into the position shown. In this position, coupling arms 88 are in a retracted position so that coupling pins 94 can be inserted through openings 110 in carrier 106.

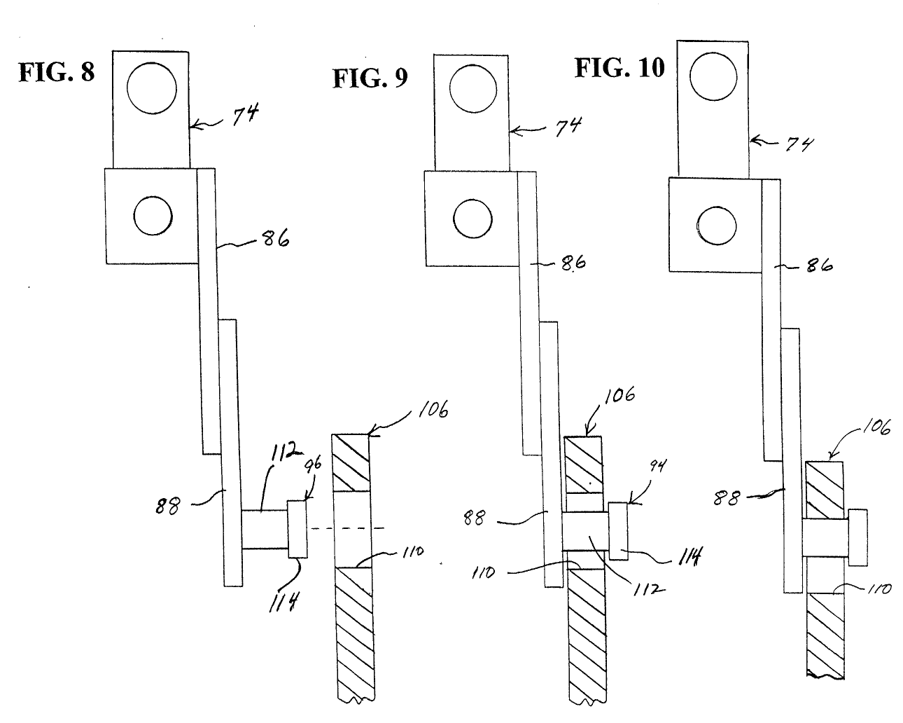

Referring to FIGS. 8-10, coupling pins 94 have a shaft 112 and a retaining head 114. Head 114 is dimensioned to pass through openings 110 in carrier 106 as shown in FIGS. 8-10 and is dimensioned to retain carrier 106 on shaft 112. Articulated arm 70 is maneuvered to insert coupling pins 94 through openings 110 of carrier 106 and coupling arms 88 are pivoted outwardly to a coupling position shown in FIG. 7 for coupling to carrier 106. Robotic assembly 12 is then actuated to remove gel 104 and carrier 106 from tank 16 and transfer gel 104 to staining station 108.

Assembly 10 includes a suitable computer for providing complete automation of robotic assembly 12. The computer is coupled to motor 52, 64, 76 and actuator 96 to control the operation of each component and coordinate the movement of the assembly. The computer is able to control the operation of each of the motors individually so that the gels can be moved to selected locations. The computer coordinates the movement of the robotic arm and the actuation of the coupling arms to enable the assembly to capture a gel from one location and transfer the gel to another.

Carrier 106 can be any suitable device capable of supporting an electrophoresis gel slab without damaging the gel. Electrophoresis gel 104 is a conventional gel used in two-dimensional electrophoresis separation as known in the art. Typically, the electrophoresis gels are made of an acrylamide material that is placed between two sheets of glass and polymerized to form the gel. The biological sample is subjected to a first dimension isoelectric focusing process step as known in the art. The gel from the first dimension separation is placed along on end of the gel between the sheets of glass. An electric potential is applied between opposite ends of the gel to cause the proteins and other macromolecules to migrate through the gel. The gel is then separated from the sheets of glass so that the isolated proteins can be recovered. The resulting gel is thin and pliable and can be difficult to handle. Typically, the gel is about 2 mm thick. The gel can tear, stretch and stick to most surfaces that it contacts. Manual handling of the gels usually results in about 10% of the gels being damaged. Therefore, the gel slab is supported by carrier 106 to manipulate the gel through the various process steps.

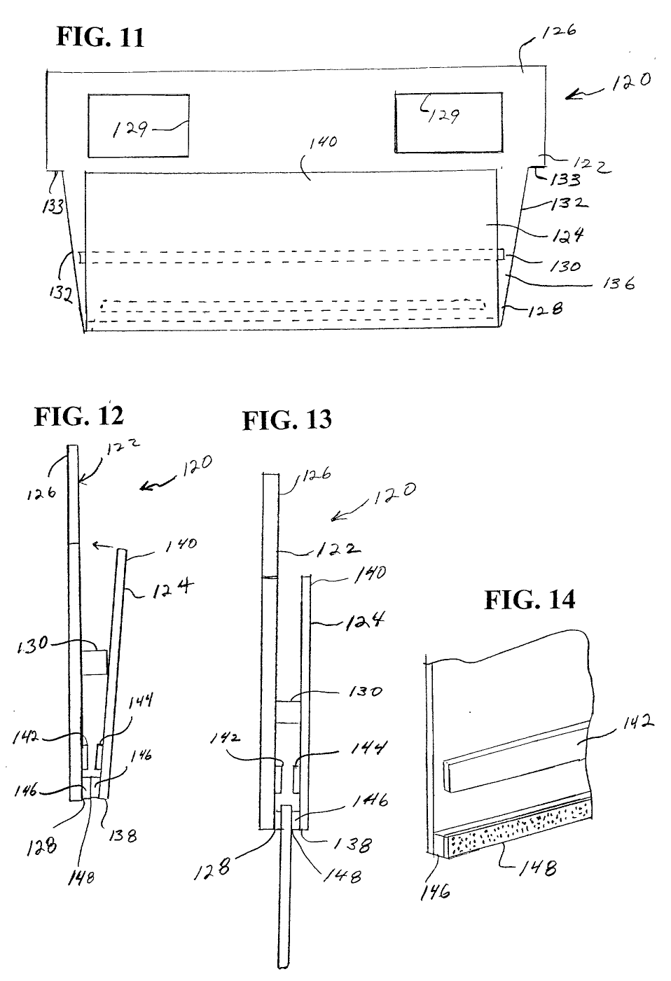

Referring to FIGS. 11-14, carrier 106 in a preferred embodiment of the invention, is in the form of a clamp 120 having a first jaw 122 and a second jaw 124. First jaw 122 has a substantially longitudinal dimension having an operating end 126 and a gripping edge 128. Gripping edge 128 is a substantially straight edge and has a length corresponding substantially to the length of gel 104. First jaw 122 has a substantially planar configuration and is formed from a sheet material that is sufficiently rigid to support a gel slab. Typically, clamp 120 is made from a rigid plastic material that is non-reactive with the gel or the various solutions used to treat the gel. In alternative embodiments, clamp 120 can be made of metal or other non-reactive materials.

As shown in FIG. 11, operating end 126 of first jaw 122 has a length slightly greater than gripping edge 128. Openings 129 are included in first jaw 122 for coupling to articulated arms 88. First jaw 122 includes side edges 132 that converge to gripping edge 128 and form a step portion 133 along each side to engage notches 102 of tanks 16 for supporting clamp 120 and suspending gel 104 in the liquid contained in tank 16. In the embodiment illustrated, a rib 134 is coupled to a top face 136 of first jaw 122. Rib 134 is spaced from gripping edge 128 and extends substantially parallel to gripping edge 128 and extends substantially the length of first jaw 122.

Second jaw 124 has a longitudinal dimension with a gripping edge 138 and an operating end 140. Gripping edge 138 of second jaw 124 is a substantially straight edge complementing gripping edge 128 of first jaw and has a length corresponding to the length of gripping edge 128 of first jaw 122. In the embodiment illustrated, second jaw 124 has a width less than the width of first jaw 122. In alternative embodiments, second jaw 124 can have a width substantially the same as or greater than the width of first jaw 122. Second jaw 124 is coupled to first jaw 122 and is pivotable about rib 134 to open and close gripping edges 128 and 138 of first jaw 122 and second jaw 124, respectively. As shown in FIGS. 12 and 13, rib 134 is dimensioned and positioned to form a fulcrum and to define a pivot point of second jaw 124 with respect to first jaw 122.

First jaw 122 and second jaw 124 have a longitudinal length to be able to grip and suspend gel 104 without tearing or stretching gel 104. It has been found that continuous griping surfaces of the clamp that extend a substantial portion of the edge of a gel slab can suspend the gel with little or no distortion or tearing. A uniform clamping pressure along the length of the gripping edges minimizes distortion and stretching of the gel.

First jaw 122 and second jaw 124 are biased by a suitable biasing device to apply a sufficient gripping pressure between gripping ends 128 and 138 to grip a gel 104 with sufficient force to support an electrophoresis gel slab. Preferably, the jaws are biased to apply a substantially uniform pressure along the length of the gripping surfaces.

In a preferred form of the invention, first jaw 122 and second jaw 124 include a magnet 142 and 144, respectively, positioned to bias gripping edges 128 and 138 together. As shown in the embodiment of FIGS. 11-13, magnets 142 and 144 are spaced a slight distance from gripping edges 128 and 138 to enable the gripping edges to engage gel slab 104. Magnets 142 and 144 in a preferred embodiment are elongated strips having a length extending a substantial length of gripping edges 128 and 138. Typically, magnets 142 and 144 are flexible magnetic plastic strips as known in the art. Magnets 142 and 144 are coupled to first jaw 122 and second jaw 124, respectively, by a suitable adhesive.

Magnets 142 and 144 are oriented to attract each other and apply a sufficient gripping pressure between gripping edges 128 and 138. It has been found that magnetic strips attached to first jaw 122 and second jaw 124 effectively couple the jaws together and provide sufficient clamping force to support a gel without other mechanical coupling devices. Preferably, magnets 142 and 144 provide a substantially uniform gripping force along the gripping edges of the jaws. In alternative embodiments of the invention, a single magnet can be provided on one of the jaws with a metal strip on the other jaw to attract the magnet.

In a preferred embodiment, gripping edges 128 and 138 of jaws 122 and 124, respectively, include a resilient member 146 to assist in gripping gel 104. Typically, resilient member 146 is a resilient strip extending the length of gripping edges 128 and 138. In preferred embodiments, resilient member 146 has a length corresponding to the dimensions of gel 104 and a width sufficient to grip gel 104 without damaging the gel. Resilient member 146 is typically a flexible and resilient material that is able to conform to the surface of gel 104 when a gripping pressure is applied. In one embodiment of the invention, a resilient member 146 is a compressible foam made of a polymeric material that is adhesively attached to gripping edges 128 and 138 of first jaw 122 and second jaw 124, respectively. Preferably, the adhesive is a waterproof adhesive that is non-reactive with the various reagents used to treat the gel.

Resilient member 146 has an outer face with a gripping surface that is capable of gripping gel 104. Preferably, resilient member 146 has a slip-resistant surface. In the embodiment illustrated, gripping surface 148 is formed by an abrasive material. The abrasive material is typically produced from a fine grit particulate material that is adhesively bonded to gripping surface 148. In alternative embodiments, a suitable substrate such as a tape having an abrasive material on one face is attached to resilient member 146. In another embodiment, resilient member 146 can be formed with a plurality of ridges or projections molded on the surface of resilient member 146 to promote gripping of gel 104. In another embodiment, a waterproof sandpaper material can be used.

Clamp 120 is used by coupling second jaw 124 to first jaw 122 as shown in FIGS. 11 and 12 by the magnetic attraction of the magnets. Magnets 142 and 144 have a sufficient attractive force to couple second jaw 124 to first jaw 122 and clamp gripping edges 128 and 138 together with sufficient clamping force to clamp an electrophoresis gel. Operating end 140 of second jaw 124 is manually pressed toward first jaw 122 to cause second jaw 124 to pivot about rib 134 to open gripping edges 128 and 138. Gel 104 is positioned between gripping surfaces 148 of resilient member 146 and magnets 142 and 144 are allowed to apply a clamping pressure against gel 104 as shown in FIG. 13.

Preferably, magnets 142 and 144 are made from flexible plastic magnetic strips that are attached to the inner opposing faces of the jaws. In alternative embodiments, the magnets can be attached to the outer face of the jaws. The magnetism of the magnets can be selected according to the location of the magnets and the desired gripping force.

FIGS. 14-17 show an alternative embodiment of a clamp 150. Clamp 150 is formed from a first jaw 152 and a second jaw 154. First jaw 152 has a substantially rectangular configuration with an operating end 156 and a gripping end 158. As in the previous embodiment, gripping end 158 is a substantially straight edge that has a length corresponding to the dimensions of a gel slab and a length sufficient to grip and support a gel. Operating end 156 includes a pair of openings 160 for engaging articulated arm assembly 70 of robotic assembly 12. A rib 162 extends parallel to gripping end 158 and is spaced between gripping end 158 and operating end 156. Rib 162 has a height and width to form a fulcrum to enable second jaw 154 to pivot with respect to first jaw 152.

Second jaw 154 has a substantially rectangular configuration with a length substantially the same as the longitudinal length of first jaw 152. In the embodiment illustrated, second jaw 154 has a width less than the width of first jaw 152, although in alternative embodiments, second jaw 154 can be substantially the same size and shape as first jaw 152. Second jaw 154 has an operating end 164 and a gripping end 166. Gripping end 166 forms a substantially straight edge complementing the edge of gripping end 158 of first jaw 152.

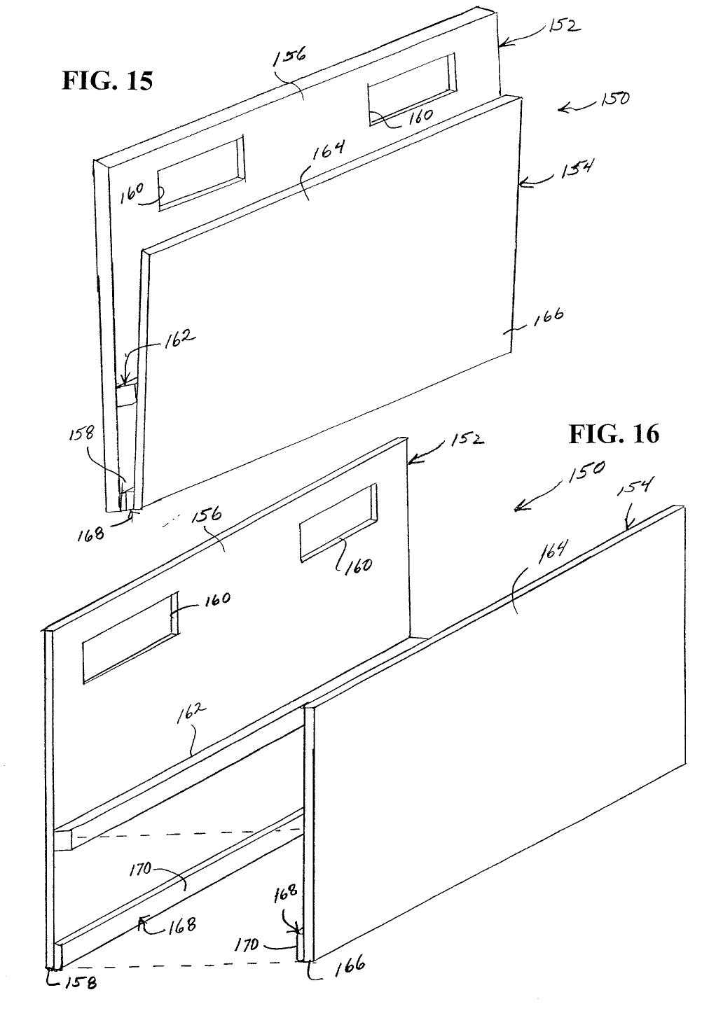

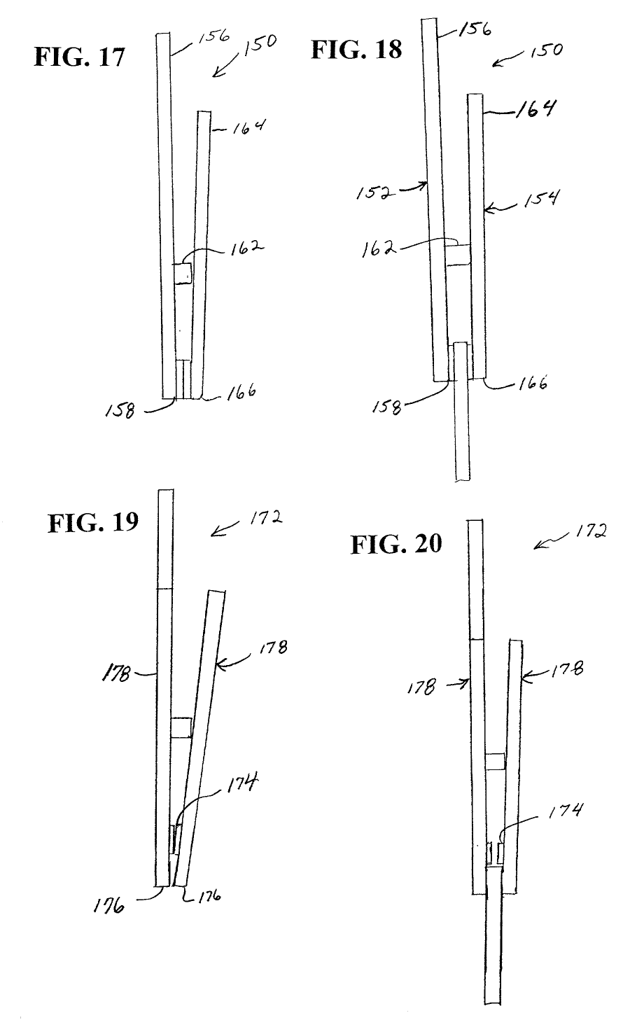

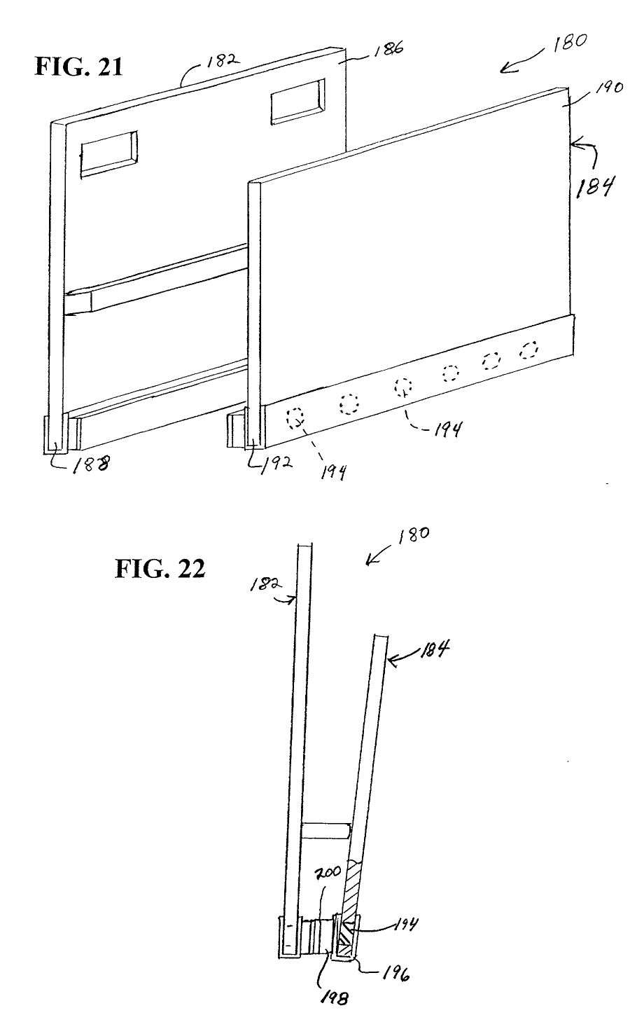

In the embodiment of FIGS. 14 and 15, a magnetic strip 168 is coupled to each gripping end 158 and 166 of first jaw 152 and second jaw 154, respectively. In this embodiment, magnetic strips 168 are oriented along the edge of first jaw 152 and second jaw 154 for gripping the gel slab as shown in FIG. 17. Preferably, magnetic strips 168 are formed from a flexible magnetic plastic strip that is adhesively bonded to jaws 152 and 154. Magnetic strips 168 have an outer surface 170 forming a gripping surface to engage the electrophoresis gel. In embodiments of the invention, outer surface 170 can be provided with a slip-resistant material such as an abrasive material to enhance the ability of magnetic strips 168 to grip and hold the electrophoresis gel. The abrasive material can be a fine grit particulate material applied directly to outer face 170 by an adhesive. Alternatively, a substrate having an abrasive particulate bonded thereto, such as a sandpaper-like material, can be coupled to outer face 170 of magnetic strips 168.

In a further embodiment shown in FIGS. 18 and 19, a clamp 172 includes magnetic strips 174 spaced from gripping edges 176 of jaws 178. Gripping edges 176 of jaws 178 can have a slip-resistant surface such as an abrasive material or surface to promote gripping of an electrophoresis gel as shown in FIG. 19.

FIGS. 20 and 21 show an alternative embodiment of a clamp 180. Clamp 180 includes a first jaw 182 and a second jaw 184. As in the previous embodiments, first jaw 182 has an operating end 186 and a gripping end 188. Second jaw 184 has an operating end 190 and a gripping end 192. Gripping ends 188 and 192 each have a plurality of spaced-apart apertures extending transversely through the respective jaw. A cylindrical magnet 194 is positioned in each of the apertures in the gripping end. Magnets 194 can be made of any suitable magnetic material. Preferably, magnets 194 are oriented with attracting poles facing each other for biasing gripping ends 188 and 192 toward each other to provide a gripping force necessary to support an electrophoresis gel slab. In the embodiment illustrated, a protective film material 196 is wrapped around the gripping ends of the jaws and is bonded thereto by a suitable adhesive. Film 196 is preferably a water resistant material to prevent corrosion of magnets 194. Film 196 can be a suitable polymeric film such as a polyester or polyethylene. A resilient strip 198 is provided on each gripping end 188 and 192 to enhance gripping of an electrophoresis gel. An abrasive strip 200 is applied to the outer surface of resilient strip 198 to further promote gripping of a gel.

In preferred embodiments of the invention, the clamping jaws include a suitable magnet for applying the clamping force for gripping an electrophoresis gel. In the embodiments illustrated, the magnets are oriented adjacent the gripping ends of the jaws to provide a magnetic attraction and bias the gripping ends of the jaws together. In alternative embodiments, the clamping jaws can be hinged together about a fixed pivot point by a suitable hinge. The jaws can be spring biased by a leaf or coil spring to apply the necessary clamping force on the gel. Alternatively, the operating ends of the jaws can include magnets having the poles oriented to repel each other to provide the clamping force of the gripping ends.

The dimensions of the clamp can vary depending on the dimensions of the gel and the robotic assembly. Preferably, the clamps have a gripping edge with a length sufficient to distribute the clamping force along the length of the gel to prevent the gel from tearing or distorting when suspended by the clamp. In further embodiments, the clamp can have spaced-apart gripping surfaces that are spaced along the length of the gel to provide the necessary clamping force. Preferably, the gripping surfaces of the clamps are dimensioned to form a continuous gripping surface along the length of the gel.

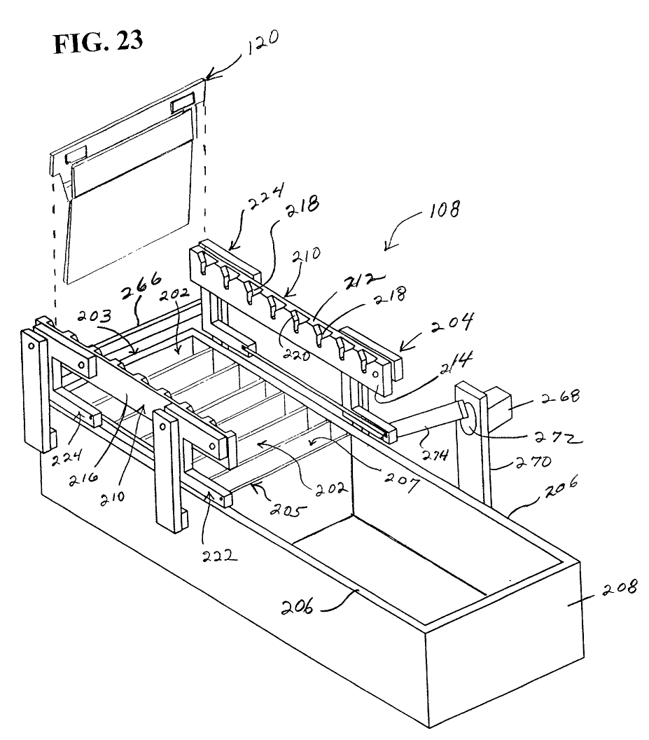

Staining station 108 preferably includes a plurality of adjacent staining tanks 202 as shown in FIG. 23. Each of the staining tanks 202 is dimensioned to contain a suitable staining reagent and an electrophoresis gel. Staining tanks 202 are oriented in a transverse direction with respect to the longitudinal dimension of apparatus 10. The various reagents are standard staining reagents as known in the art, such as stains, developing reagents, fixing reagents and rinsing solutions. Typically, staining tanks 202 contain the various reagents arranged in the sequence of use. Robotic assembly 12 is provided to sequentially transfer gel 104 to each tank 202 for sufficient time to treat the gel. After a predetermined treatment time, robotic assembly 12 removes gel 104 from one tank 202 and transfers gel 104 to the next tank 202 for the next treatment step.

Referring to FIG. 23, staining station 108 includes an agitating assembly 204 positioned above staining tanks 202. As shown in FIG. 23, staining tanks 202 are assembled as an integral unit to form longitudinal side walls 206 and end walls 208. Staining tanks 202 are arranged in sequence to contain the various reagents in the order of their use. In this embodiment, for example, staining tanks 202 are arranged from an upstream end 203 of station 108 to a downstream end 205. Preferably, the upstream tank 202 contains a staining solution. The developing reagents, fixing reagents and other reagents are provided in downstream tanks 202. Robotic assembly 12 is programmed to transfer gel 104 from one tank 202 to another according to the protocol of the staining process. In a preferred embodiment, a rinse tank 207 is provided at downstream end 205. Robotic assembly 12 is programmed to transfer gels 104 at the end of the staining process from staining tanks 202 to rinse tank 207 for time sufficient to rinse the reagents from the gel. In embodiments of the invention, robotic assembly 12 is programmed to transfer gel 104 to rinse tank 207 between each processing step to rinse the reagents from gel 104 before transferring to the next reagent to minimize contamination of the subsequent reagents by the residue of the previous reagent on the gel.

Agitating assembly 204 includes support rails 210 positioned above a top edge of side walls 206 and extend in a longitudinal direction of station 108. Support rails 210 are oriented along side walls 206 at opposite ends of staining tanks 202. Support rails 210 have a top face 212, an inner face 214 and an outer face 216. A plurality of spaced apart notches 218 are formed in inner face 214 and extend to top face 212. Notches 218 have a beveled top surface 220 converging toward bottom end of notches 208. As shown in FIG. 23, support rails 210 are positioned on opposite sides of staining tanks 202 and rinse tank 207 with notches 218 aligned with the center of a respective staining tank 202 and rinse tank 207. Notches 218 are dimensioned to receive and support a carrier 106 supporting a gel 104 for suspending gel 104 in a respective staining tank 202 in a manner similar to that shown in FIG. 6.

Support rails 210 are mounted for continuous reciprocating movement in a vertical direction to move gel 104 within the reagent, thereby continuously agitating the reagent in staining tanks 202. In this embodiment, support rails 210 continuously reciprocate in a vertical direction, although in alternative embodiments, support rails 210 can oscillate in a horizontal direction to continuously agitate the reagent. Continuous agitation of the reagent in staining tanks 202 provide uniform distribution of reagents and substantially uniform temperature throughout the surfaces of gel 104 during the staining steps. Robotic assembly 12 is programmed to transfer gels 104 to selected positions on rails 210 for treatment tank 202.

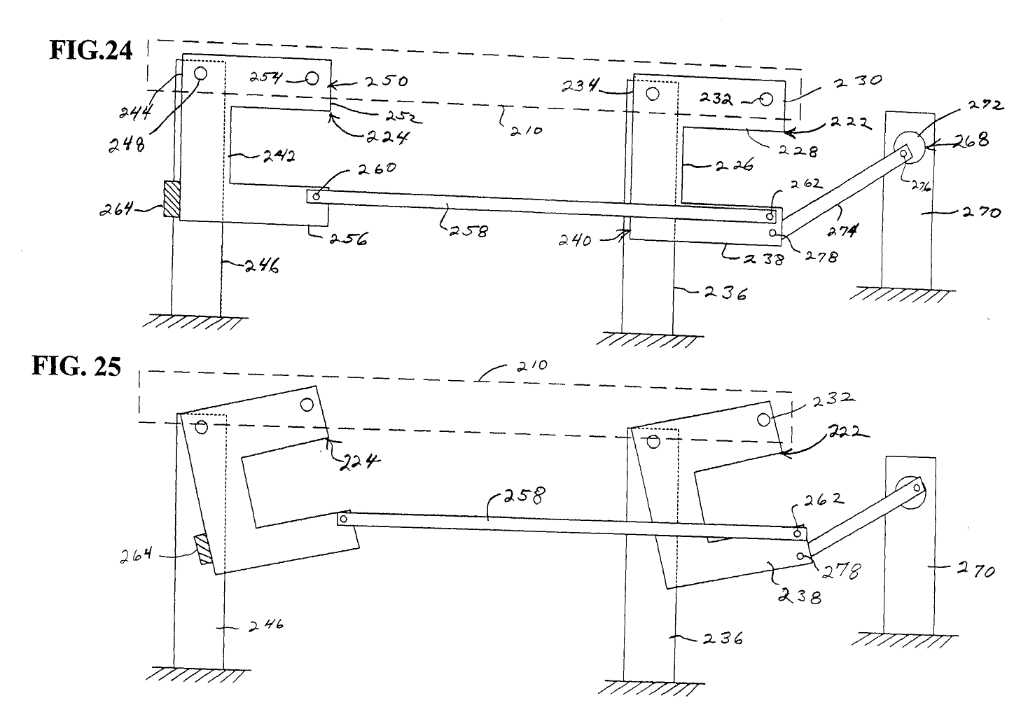

Referring to FIGS. 24 and 25, each support rail 210 is coupled to a forward bracket 222 and a trailing bracket 224. Bracket 222 includes a body portion 226 having a top leg 228 extending substantially perpendicular to body 226. Leg 228 has an outer end 230. Outer end 230 of leg 228 is pivotally coupled to a forward end of support rail 210 by a pivot pin 232. A top end 234 of body 226 is pivotally coupled to a fixed support 236. As shown in FIG. 23, fixed support 236 is coupled to a respective side wall 206. In the embodiment illustrated, a bottom leg 238 extends from a bottom end 240 of body 226 in a direction substantially parallel to top leg 228.

Bracket 224 is similar to bracket 222 and is positioned to support an opposite end of the respective support rail 210. Bracket 224 includes a body portion 242 having a top end 244 pivotally coupled to a fixed support 246 by a pivot pin 248. A top leg 250 extends from top end 244 of body 242 to an outer end 252. Outer end 252 of leg 250 is pivotally coupled to a rearward end of a respective support rail 210 by a pivot pin 254. Bracket 224 also includes a bottom leg 256 extending from body 242 in a direction substantially parallel to top leg 250. A connecting rod 258 is pivotally connected to bottom legs 238 and 256 by pivot pins 260 and 262, respectively. As shown in FIGS. 24 and 25, connecting rod 258 enables brackets 222 and 224 to pivot simultaneously to produce a reciprocating motion to support rails 210 in a substantially vertical direction.

Brackets 224 coupled to the respective support rail 210 are connected together by a brace 266 extending between the brackets 224. In this manner, the pivoting brackets are connected together to move in unison so that each support rail 210 reciprocates simultaneously. At least one of the brackets 222 is connected to a drive motor 268. Drive motor 268 is mounted to a fixed support 270 and includes an eccentrically mounted crank 272. Crank 272 is coupled to a connecting arm 274 by a pivot pin 276. Connecting arm 274 extends to bottom leg 238 of forward bracket 222 and is coupled thereto by a pivot pin 278. As shown in FIGS. 24 and 25, motor 268 is actuated to rotate crank 272 to produce a pivoting movement of brackets 222 and 224 about pivot pins 232 and 248, respectively. The pivotal movement of brackets 222 and 224 result in a reciprocating motion of support rails 210 in a substantially vertical direction. Motor 268 is connected to a suitable power source and is controlled by a microprocessor to control the timing, speed of motor 268 and the desired sequencing of the agitation of the respective gel and reagent.

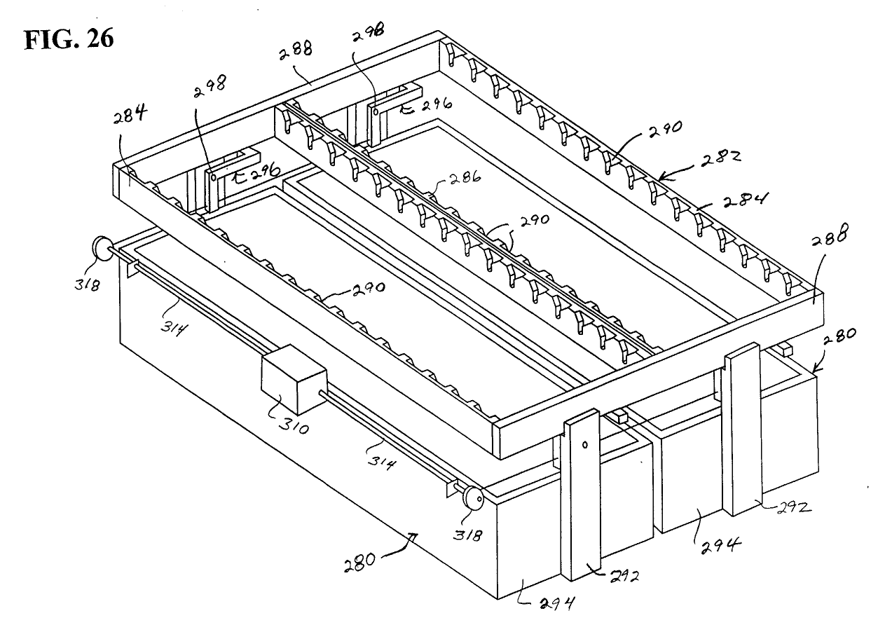

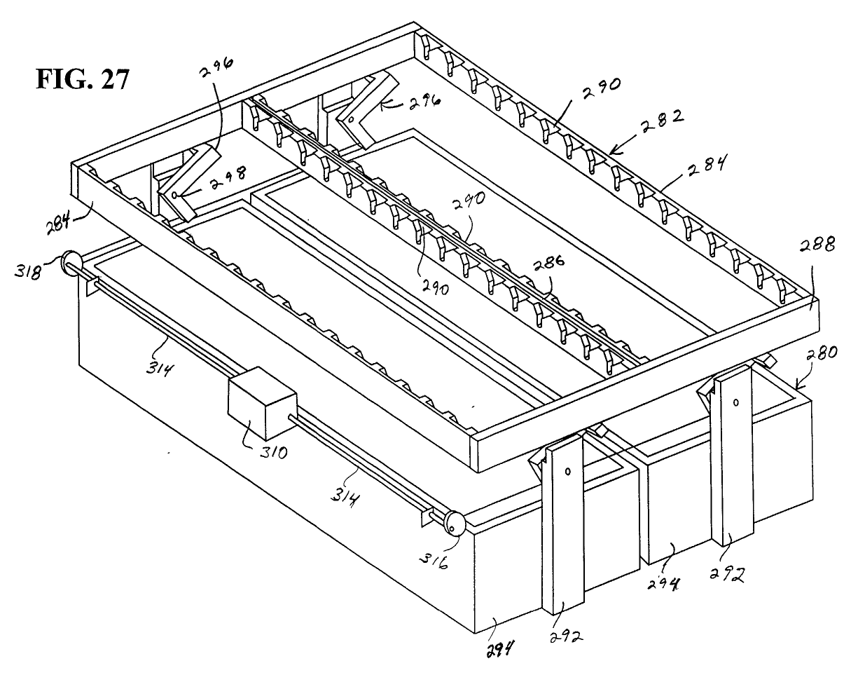

FIGS. 26-29 illustrate an alternative embodiment of an agitation assembly. In this embodiment, two substantially identical tanks 280 are arranged in a side-by-side relation as shown in FIG. 26. Tanks 280 are dimensioned to contain a liquid reagent or buffer solution for treating an electrophoresis gel slab. A supporting frame 282 is positioned above tanks 280. Frame 282 includes side rails 284 and a center rail 286. End rails 288 extend between side rails 284 and center rail 286 to define a substantially rigid frame. Side rails 284 have an inner surface formed with a plurality of spaced apart notches 290 for supporting a carrier and gel slab as in the previous embodiment. Center rail 286 includes notches 290 on each side aligned with a respective notch 290 on side rails 284.

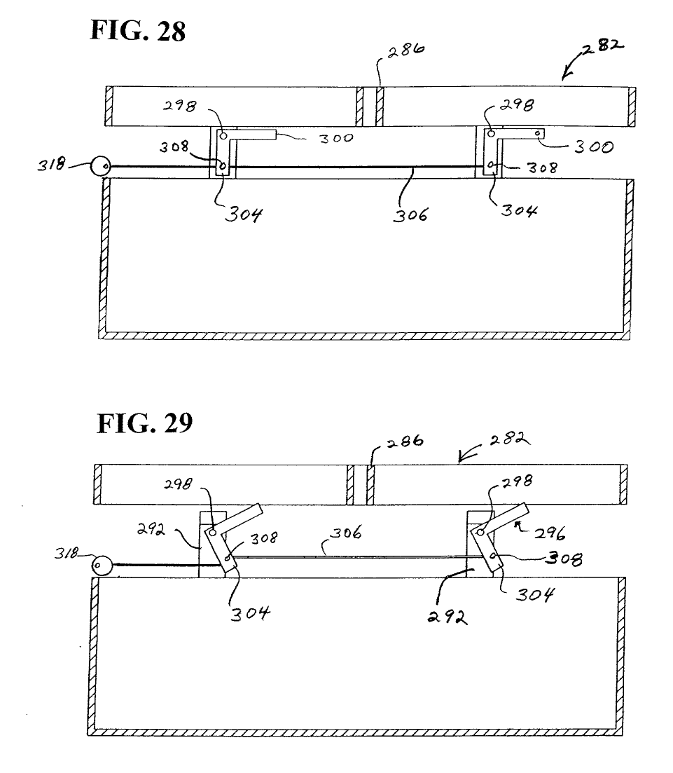

Fixed supports 292 are coupled to end walls 294 of tanks 280. A substantially L-shaped bracket 296 is pivotally coupled to each support 292 by a pivot pin 298. Brackets 296 include a first leg 300 connected to frame 282. Brackets 296 include a second leg 204 extending substantially perpendicular to first leg 300. As shown in FIG. 28, second legs 204 of brackets 296 at each end of frame 282 are connected together by a connecting rod 306. Connecting rod 306 is coupled to each leg 304 by a pivot coupling 308.

A drive motor 310 is positioned to operate connecting rods 306 to pivot brackets 296 about pivot pins 298. In one embodiment, drive motor 310 is connected to a drive shaft 312 having eccentrically mounted cams 314, which engage an end of connected rods 306. Rotation of drive shaft 312 and cams 314 produce an oscillating motion to connecting rods 306, which pivot brackets 296 and produce an oscillating motion to frame 282 in a substantially vertical direction.

In an alternative embodiment, connecting rods 306 are connected to a common bar to connect brackets 296 at opposite ends of frame 282 together. A drive motor having a cam or other drive system can be included to engage the bar and produce a reciprocating motion to the bar and connecting rods 306.

Staining tanks 202 are dimensioned to contain a reagent and an electrophoresis gel slab by suspending the gel slab in the reagent. As shown in FIGS. 30-36, staining tanks 202 have side walls 318, end walls 320, and a bottom wall 322. Side walls 318 in the embodiment illustrated are oriented substantially vertical and parallel to each other. Side walls 318 include a top end 324 that is angled outwardly from the center of staining tank 202 to form inclined surfaces 326. Inclined surfaces 326 open outwardly to form a guide surface for directing a gel into a respective staining tank 202 as the gel is lowered by robotic assembly 12.

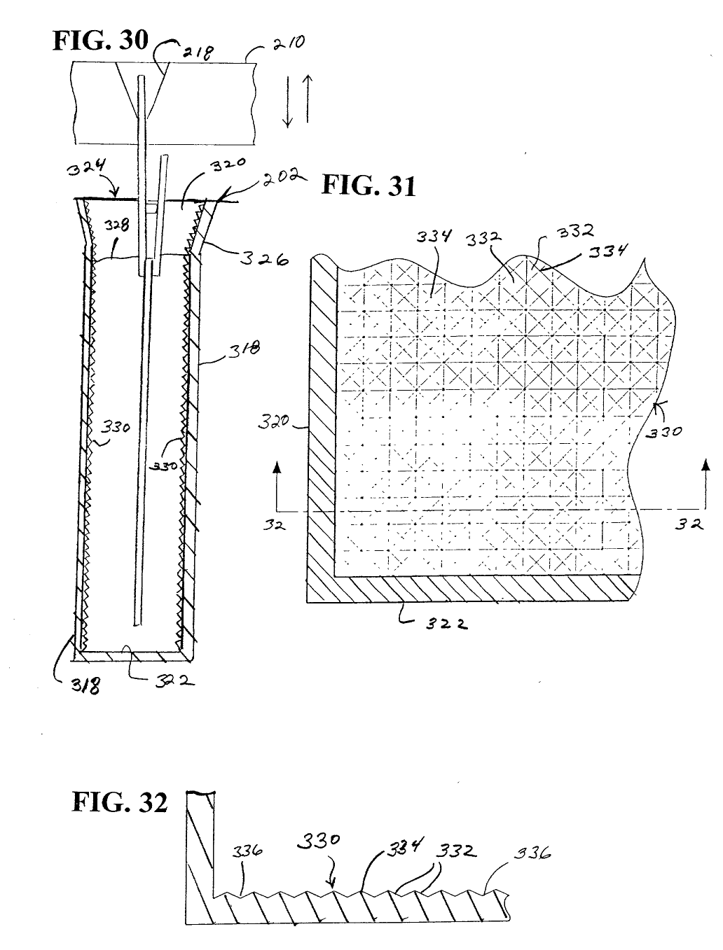

As shown in FIG. 30, gel 104 is coupled to carrier 106 and suspended by rails 210 in a respective staining tank 202. Gel 104 is moved in a substantially up and down reciprocating motion to agitate in liquid reagent 328. Gel 104 is flexible and can stick or adhere to side walls 318. To prevent gel 104 from adhering to side walls 318, side walls 318 are provided with a textured surface to limit the surface area of side walls 318 that contact gel 106. In a preferred embodiment of the invention, side walls 318 are formed with a plurality of projections 330 extending outwardly from side wall 318. Typically, projections 330 are arranged in a substantially uniform array of rows and columns as shown in FIG. 31.

Projections 330 in one embodiment of the invention have a substantially pyramid shape with facets 332 converging to a peak 334. Peak 334 form channels 336 between adjacent peaks. Channels 336 have a depth and a width to allow liquid to flow through channels 336 when gel 106 contacts side wall 318. Preferably, channels 336 have a dimension to allow a sufficient volume of liquid to flow between gel 106 and side wall 318 and release the suction effect produced when gel 106 is pulled away from side wall 318, thereby releasing gel 106 and reducing the risk of stretching or damaging gel 106.

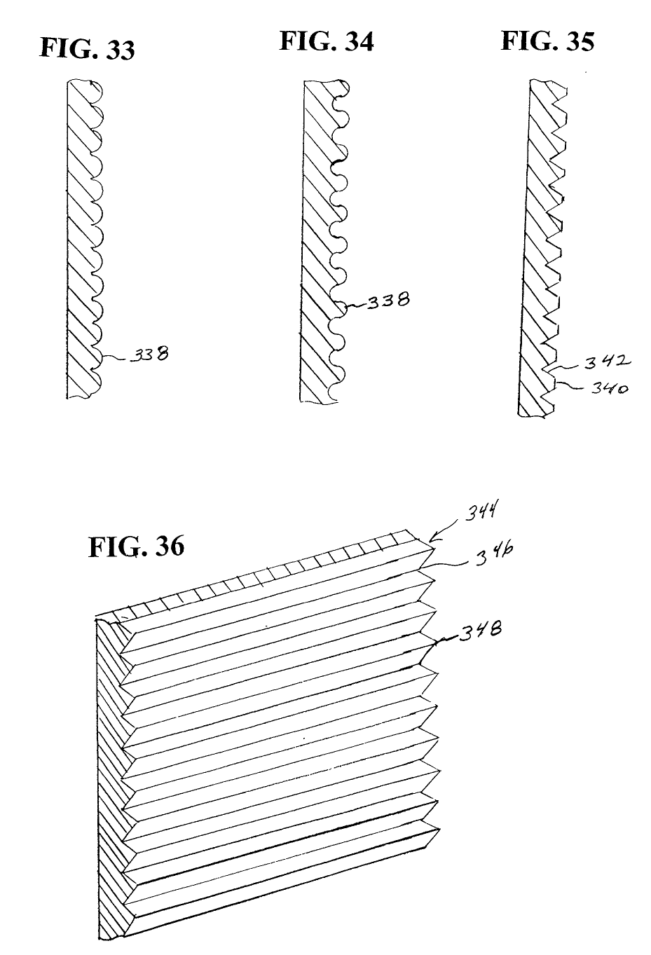

As shown in FIG. 32, projections 330 have a substantially uniform shape and dimension. In alternative embodiments, the projections can be staggered in rows and columns and have different lengths or widths. In further embodiments, the projections can have a rounded convex surface having a generally dome or bubble shape as shown in FIG. 33 and FIG. 34. In another embodiment shown in FIG. 35, the projections can have a flat top surface 340 separated by recesses 342. Recesses 342 shown in FIGS. 35 have a generally V-shape with straight sides. Alternatively, the recesses can have curved faces. In still further embodiments, the projections can be substantially parallel ridges 344 having channels 346 between adjacent ridges as shown in FIG. 36. In the embodiment of FIG. 36, ridges 344 have a substantially triangular cross-section with surfaces converging to a tip 348. In further embodiments, ridges 344 can have a rounded convex surface. Ridges 344 can be oriented vertically or horizontally on side walls 318.

The projections and the recesses form channels to enable the liquid between the gel and the surface of side wall 318 to inhibit the gel from adhering to the surface. It will be appreciated that the actual shape, dimension and number of projections and channels can vary to provide the gel-releasing, non-stick surface.

During the staining process of an electrophoresis gel, the proteins and macromolecules are stained so that the molecules are visible. In embodiments of the invention, several images of the gel are obtained during the developing process to provide a record of the staining process. Since certain proteins and macromolecules appear at different times during the staining process, a sequence of pictures can be used to identify and distinguish the proteins and macromolecules.

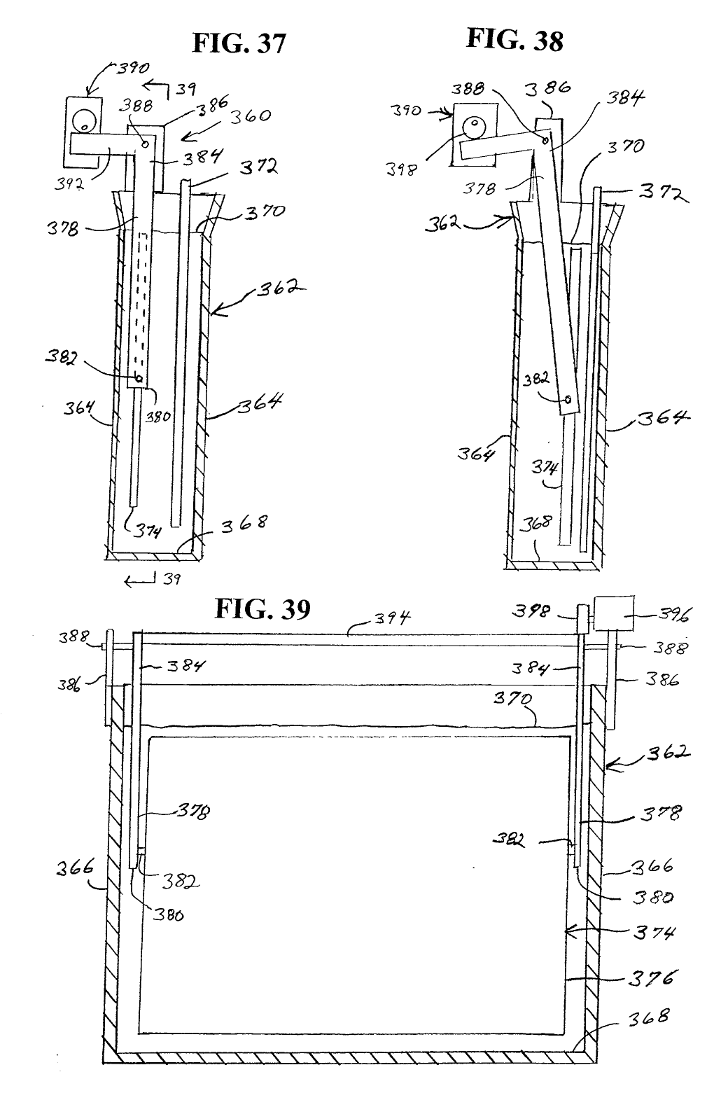

Referring to FIGS. 37-40, an agitating assembly 360 is provided in a developing and imaging tank 362. Developing tank 362 includes side walls 364, end walls 366 and bottom wall 368. Preferably, side walls 364 are substantially parallel and vertical. As shown in FIG. 37, tank 362 is dimensioned to contain a developing reagent 370 and a gel slab 372. Robotic assembly 12 is programmed to transfer a selected gel and its respective carrier between a staining tank 202 and developing tank 362. In one embodiment of the invention, robotic assembly 12 is programmed to move a selected gel from a staining tank 202 to rinse tank 207 and then to developing tank 362.

Agitating assembly 360 includes an agitating plate 374 suspended in developing reagent 370. Plate 374 in preferred embodiments has a dimension complementing the interior dimension of tank 362 and has a dimension at least equal to the dimensions of gel 372. Agitating plate 374 in the illustrated embodiment is a solid plate having a substantially planar configuration that can be made of transparent glass or plastic. Generally, plate 374 is made of metal. In alternative embodiments, agitating plate 374 can have perforations to allow the liquid to flow through the perforations during agitation. In further embodiments, agitating plate 374 can be a rigid mesh material having sufficient strength to agitate reagent 370.

Agitating plate 374 has side edges 376 that are connected to an agitating arm 378. Arms 378 have a bottom end 380 and are connected to side edges 376 of agitating plate 374 by a pivot pin 382. Preferably, pivot pin 382 is connected to a mid portion of side edges 376 as shown in FIG. 38.

Agitating arms 378 have an upper end 384 pivotally coupled to a fixed support 386 by a pivot pin 388. In the embodiment illustrated, support 386 is coupled to end walls 366 of tank 362.

A drive assembly 390 is operatively connected to agitating arms 378 to produce an oscillating motion to arms 378 about pivot pin 388.

In the illustrated embodiment, agitating arms 378 include a leg 292 extending from upper end 384 in a direction substantially perpendicular to the longitudinal axis of agitating arms 378. Legs 392 are connected together by a connecting bar 394 as shown in FIG. 39. Drive assembly 390 in this embodiment includes a motor 396 having a cam member 398. Motor 396 is operated to rotate cam 398 to engage leg 392 to pivot agitating arm 378 about pivot pin 388. As shown in FIGS. 37 and 38, cam 398 produces an oscillating motion of agitator plate 374 in a substantially linear direction perpendicular to side walls 364. Agitating plate 374 is pivotally coupled to agitating arms 378 so that agitating plate 374 can remain parallel to side walls 364 during the agitating motion.

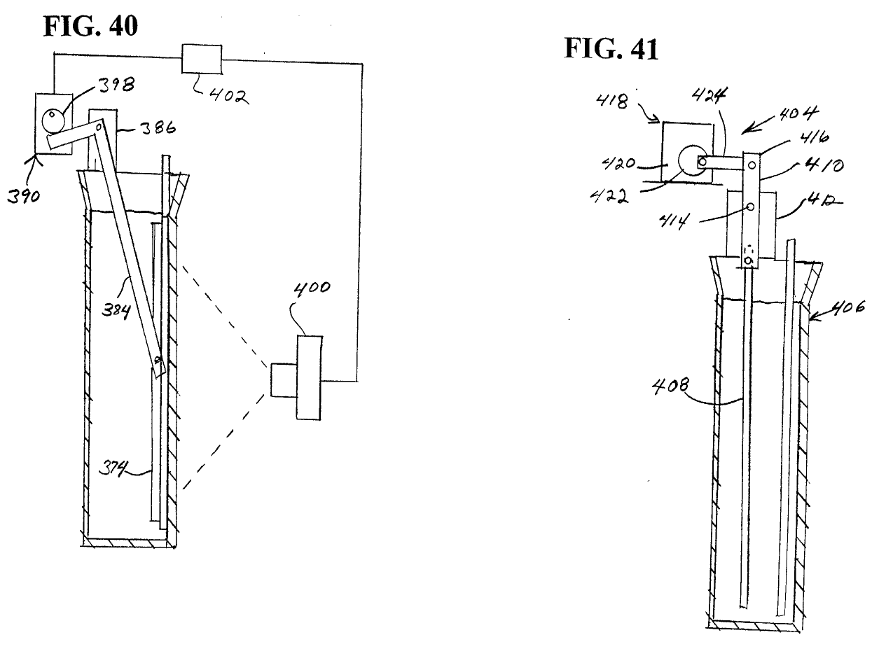

During the developing stage of the gel, motor 396 is continuously operated to produce a continuous agitating motion to plate 374. In a preferred embodiment of the invention, side wall 364 is transparent and a suitable imaging device 400 is positioned adjacent transparent side wall 364. Imaging device 400 can be a camera, video device, or CCD imaging device capable of capturing and recording an image of gel 372 in tank 362. As shown in FIG. 40, drive assembly 390 is connected to a controller 402. At selected time intervals, during the developing stage, controller 402 actuates drive assembly 390 to pivot agitating arm 378 to the position shown in FIG. 40 so that agitating plate 374 presses gel 372 against transparent side wall 364. At that time, controller 402 actuates imaging device 400 to capture an image of gel 372. In this manner, sequential images can be captured to record the various stages during the developing process.

In embodiments of the invention, a robotic assembly 12 is programmed to select a gel from a staining tank 202, transfers the gel to rinse tank 207 for a predetermined period of time, and then transfers the gel to developing tank 362. After one or more images of the gel are captured, robotic assembly 12 returns the gel to the staining tank 202 for further processing. The gel is again transferred to developing tank 362 after further processing to obtain a sequence of images for the gel during the staining process. Robotic assembly 12 is capable of sequentially transferring several gels between the various tanks for capturing sequential images of several gels. The computer control system of robotic assembly 12 maintains a record of the location of each gel being processed, the stage of the process for each gel and coordinates a captured image with the particular gel.

FIG. 41 shows an alternative embodiment of an agitating assembly 404 in a developing tank 406. Agitating assembly 404 includes an agitating plate 408 connected to an agitating arm 410. Agitating arm 410 is pivotally connected to a support 412 by a pivot pin 414. In this embodiment, arm 410 is pivotally connected at a midpoint to support 412. Arm 410 has a top end 416 spaced from pivot pin 414. A drive assembly 418 includes a motor 420 having a rotating crank 422. A connecting rod 424 extends from crank 422 to top end 416 of agitating arm 410. Motor 420 rotates crank 422 to produce a pivoting movement of arm 410 about pin 414 which moves agitating plate 408 in a reciprocating motion toward the side wall of tank 406.

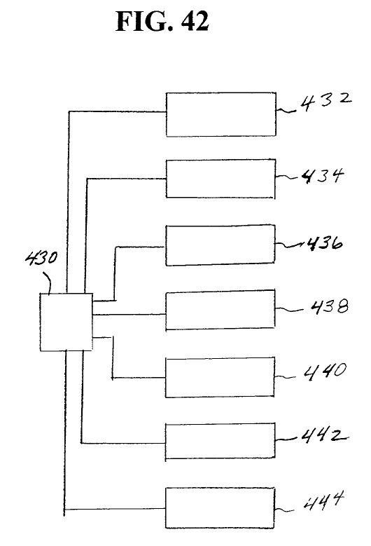

The automated apparatus of the invention is controlled and operated by a computer or central processing unit. FIG. 42 represents the control system for the apparatus which includes a central processing unit indicated by block 430. The central processing unit is operatively connected to drive motor 52 for controlling the movement of the robotic assembly along frame 18 indicated by block 432, motor 64 for raising and lowering boom 32 indicated by block 434, and the motor for moving the articulated arm along the length of boom 32 indicated by block 436 and the actuator device for operating the articulated arms indicated by block 438. The central processing unit is also operatively connected to the drive assembly for agitating assembly 360 indicated by block 440 and agitator assembly 404 indicated by block 442 and imaging device 400 indicated by block 444.

The computer controlled operating system of the invention coordinates the various processing steps for treating a plurality of electrophoresis gels. In preferred embodiments of the invention, the computer operating system continuously manipulates a plurality of gels through the apparatus and maintains a record of the progress of each gel as it passes through the respective stages. The operation and movement of robotic assembly 12 for capturing a gel from a storage tank, transferring the gel to the various treatment tanks and length of time gels remain in the various tanks are controlled and recorded by a main computer. The computer is also able to record an identification code for a selected gel and monitor the location of the gel throughout the processing steps. The computer system also controls the operation and sequencing of the agitating devices to coordinate the agitation with the movement and transfer of the gels.

While various embodiments of the invention have been chosen to illustrate the invention, it will be understood by those skilled in the art that additions and modifications can be made without departing from the scope of the invention as defined in the appended claims.

What is claimed is:

1. A clamp for holding and transporting an electrophoresis gel slab, said clamp comprising:
a first jaw having an operating end and a gripping end; and
a second jaw coupled to and being movable with respect to said first jaw, said first jaw having an operating end and gripping end, said gripping ends of said first and second jaws having a longitudinal dimension to grip and suspending a gel slab without damaging the gel slab, and said gripping end of said second jaw being biased toward said gripping end of said first jaw for gripping a gel slab.

2. The clamp of claim 1, wherein said clamp comprises at least one magnet for biasing said gripping ends of said first and second jaws together.

3. The clamp of claim 1, wherein said gripping end of said first jaw includes a first magnet and said gripping end of said second jaw includes a second magnet for biasing said gripping ends together.

4. The clamp of claim 3, wherein said first and second magnets are magnetic plastic strips.

5. The clamp of claim 1, wherein said second jaw is pivotable with respect to said first jaw to open and close said gripping ends of said jaws.

6. The clamp of claim 5, wherein said first jaw includes a fulcrum for pivoting said second jaw with respect to said first jaw.

7. The clamp of claim 6, wherein said fulcrum is positioned between said gripping end and said operating end of said first jaw and extends substantially parallel to said gripping end.

8. The clamp of claim 1, wherein said gripping ends of said first and second jaws have a slip resistant surface for gripping said gel slab.

9. The clamp of claim 1, wherein said first jaw has a height defined by a distance between said operating end and said gripping end, and said second jaw has a height defined by a distance between said operating end and gripping end, and wherein said height of said first jaw is greater than said height of said second jaw.

10. The clamp of claim 1, wherein said operating end of said first jaw includes at least one opening dimensioned to receive a carrier assembly for manipulating said clamp.

11. The clamp of claim 1, wherein said operating end of said first jaw has a longitudinal length greater than a longitudinal length of said second jaw.

12. The clamp of claim 11, wherein said operating end of said first jaw has a shoulder at opposite ends, each said shoulder being dimensioned for engaging a support to suspend a gel in a substantially vertical direction.

13. The clamp of claim 1, wherein said first and second jaws are formed from a substantially planar sheet material.

14. The clamp of claim 13, wherein said sheet material is selected from the group consisting of metal, glass and plastic.

15. The clamp of claim 1, wherein said clamp further comprises a hinge coupled to said first and second jaws, wherein said second jaw is pivotable with respect to said first jaw.

16. The clamp of claim 1, wherein said gripping end of said first and second jaws include a resilient cushion member.

17. The clamp of claim 15, wherein said resilient cushion member has a slip-resistant surface.

18. The clamp of claim 17, wherein said cushion member is a resilient polymeric foam.

19. The clamp of claim 1, wherein said gripping ends of said first and second jaws include a plurality of particles forming a textured gripping surface.

20. A method of manipulating an electrophoresis gel slab, said method comprising the steps of:
providing a clamp having a first jaw with an operating end and a gripping end, and a second jaw with an operating end and a gripping end, said gripping ends being biased toward each other;
providing a gel slab having a length, a width and a side edge;
positioning said side edge between said gripping ends of said jaws and biasing said gripping ends toward said gel slab with sufficient pressure to grip said gel slab; and
lifting said clamp and vertically suspending said gel slab, said gripping ends of said jaws being biased together under sufficient force to grip said side edge of said gel slab substantially without tearing said gel slab.

21. The method of claim 20, comprising the step of moving said carrier to a position above a gel staining tank containing a staining liquid, and lowering said gel slab into said staining liquid for sufficient time to stain said gel.

22. The method of claim 20, wherein said first and second jaws of said clamp include a magnet for biasing said gripping ends together.

23. The method of claim 20, wherein said magnets are coupled to said gripping ends of said first and second jaws.

24. The method of claim 20, wherein said second jaw pivots about an axis between an open position and a gripping position, said method comprising retaining said second jaw in said open position while positioning said side edge of said gel slab between said gripping ends, and thereafter releasing said second jaw to grip said gel slab.

25. An automated apparatus for manipulating an electrophoresis gel slab, said apparatus comprising
a robotic arm, said robotic arm being movable in a first substantially horizontal direction, a second substantially horizontal direction and a vertical direction between a plurality of work stations;
a carrier assembly coupled to said robotic arm, said carrier assembly having at least one coupling arm for removably coupling to an electrophoresis gel slab and being movable between a coupling position and an uncoupling position; and
a microprocessor operatively coupled to said robotic arm and said carrier assembly for manipulating a gel slab between said work stations.

26. The apparatus of claim 25, further comprising:
a substantially linear guide support extending between said work stations;
a vertical support coupled to said linear guide support and being movable along a longitudinal length of said linear guide support in said first direction; and
a boom having a longitudinal dimension coupled to said vertical support, wherein said carrier assembly is coupled to said boom and movable along said longitudinal dimension of said boom in said second direction.

27. The apparatus of claim 26, wherein said boom has a first end coupled to said vertical support and a second end spaced outwardly from said vertical support, and wherein said boom is movable in said substantially vertical direction along said vertical support.

28. The apparatus of claim 25, further comprising:
a storage vessel dimensioned for storing a plurality of said electrophoresis gel slabs; and
at least one treatment tank for treating said gel slab, wherein said robotic arm and carrier assembly moves said gel slab between said storage vessel and said treatment tank.

29. The apparatus of claim 28, comprising a plurality of said treatment tanks, and wherein said robotic arm and carrier assembly are able to move said gel slabs sequentially to each of said treatment tanks.

30. The apparatus of claim 28, wherein said treatment tank has first and second side walls and end walls extending between said side walls to define a cavity for containing a treating liquid.

31. The apparatus of claim 30, wherein at least one of said side walls has an inner surface to inhibit said electrophoresis gel slab from adhering to said side wall.

32. The apparatus of claim 31, wherein said inner surface of said at least one side wall has a plurality of outwardly extending projections to limit contact of said gel slab with said side wall.

33. The apparatus of claim 32, wherein said projections are spaced apart a distance to define a liquid channel between adjacent projections.

34. The apparatus of claim 32, wherein said projections have a substantially pyramid shape.

35. The apparatus of claim 32, wherein said projections have an apex spaced from said side wall, said apex having a surface area to limit contact of said gel slab with said side wall.

36. The apparatus of claim 32, wherein said projections are arranged in a substantially uniform array.

37. The apparatus of claim 30, further comprising an agitator for agitating said treating liquid.

38. The apparatus of claim 37, wherein said agitator comprises a plate vertically disposed in said treating liquid and an operating assembly for reciprocating said plate in a direction toward said second side wall.

39. The apparatus of claim 38, wherein said agitator comprises a pair of operating arms pivotally coupled to opposite side edges of said plate, and wherein said operating arms are operatively coupled to said operating assembly.

40. The apparatus of claim 39, wherein each of said operating arms have an upper end pivotally coupled to a fixed support, and a lower end coupled to said plate.

41. The apparatus of claim 28, wherein said treatment tank comprises a gel agitator for agitating said electrophoresis gel in a treating liquid contained in said treatment tank.

42. The apparatus of claim 41, wherein said gel agitator reciprocates said gel slab in a substantially vertical direction.

43. The apparatus of claim 42, wherein said gel agitator comprises a frame for suspending said gel slab in said treating liquid, and wherein said apparatus further comprises a drive assembly for reciprocating said frame and suspended gel slab in said vertical direction.

44. The apparatus of claim 43, wherein said drive assembly comprises at least one arm having a first end pivotally coupled to said frame and a second end pivotally coupled to a fixed support.

45. The apparatus of claim 44, further comprising a drive assembly operatively coupled to said arm for pivoting said arm about said fixed support.

46. The apparatus of claim 45, wherein said arm includes a leg extending from said second end, and wherein said drive assembly is operatively coupled to said leg for pivoting said arm about said fixed support.

47. The apparatus of claim 46, wherein said drive assembly comprises a motor having a crank member and a connecting member operatively connecting said crank member to said leg of said arm.

48. The apparatus of claim 46, wherein said drive assembly comprises a motor having a cam member, said cam member being operatively connected to said leg.

49. A tank assembly for treating an electrophoresis gel with a treating liquid, said tank assembly comprising:
a treatment tank having a side wall and being dimensioned to contain a liquid bath;
an agitator, said agitator including a movable agitator member positioned in said tank and being movable toward said side wall; and
a drive member coupled to said agitator for moving said agitator and agitating the liquid contained in said tank.

50. The assembly of claim 49, wherein said agitator member reciprocates along a plane substantially perpendicular to said side wall to agitate said liquid.

51. The assembly of claim 49, wherein said agitator member is a planar member having a dimension complementing a dimension of the electrophoresis gel.

52. The assembly of claim 49, wherein said agitator member is a plate having a dimension complementing a dimension of said side wall, and wherein said plate is oriented substantially perpendicular to said side wall.

53. The assembly of claim 52, wherein said side wall is substantially vertical.

54. The assembly of claim 52, wherein said plate moves in a substantially horizontal direction with respect to said side wall.

55. The assembly of claim 49, wherein said agitator member has a top edge, a bottom edge and opposite side edges, and wherein said agitator includes a pair of arms coupled to said drive member and to each of said opposite side edges.

56. The assembly of claim 55, wherein said arms are pivotally coupled to said side edges of said agitator member.

57. The assembly of claim 56, wherein said arms are pivotally coupled to a middle portion of said side edges of said agitator member.

58. The assembly of claim 56, wherein said arms have a top end and a bottom end, said top end of said arms being pivotally coupled to a support, and said bottom end being pivotally coupled to said side edges of said agitator member.

59. The assembly of claim 58, wherein said support is a fixed support and said arms pivot about a pivot axis with respect to said fixed support.

60. The assembly of claim 59, further comprising a leg extending from said top end of said arm, and wherein said drive member is operatively connected to said leg to pivot said arm with respect to said support.

61. The assembly of claim 52, wherein said agitator is movable toward said side wall to position the electrophoresis gel against said side wall for a predetermined period of time.

62. The assembly of claim 61, wherein said side wall is transparent and said assembly includes an imaging device for recording an image of the electrophoresis gel through said side wall when said gel is pressed against said side wall.

63. The assembly of claim 62, further comprising a computer controlled automated robotic arm for transferring an electrophoresis gel to said tank.

64. The assembly of claim 63, further comprising at least one staining tank for staining said electrophoresis gel and a rinse tank for rinsing said electrophoresis gel, wherein said automatic robotic arm is programmed to move said electrophoresis gel between said staining tank and said rinse tank, and between said rinse tank and said treatment tank.

65. The assembly of claim 64, wherein said robotic arm is programmed to move said electrophoresis gel from said treatment tank to said staining tank.

66. A treatment container for treating an electrophoresis gel, said container comprising:
a side wall having an inner face and an outer face, said inner face having a plurality of spaced-apart projections extending inwardly toward an interior region of said container, said projections being spaced apart a distance to define a recess between adjacent projections, said projections having an outer face with a surface area sufficient to support a gel slab and to prevent said gel slab from adhering to said side wall when said container contains a liquid.

67. The container of claim 66, wherein said container comprises two opposing side walls defining said interior region of said container, each of said side walls having projections extending inwardly with respect to said container and being dimensioned to prevent said gel slab from adhering to said side walls.

68. The container of claim 66, wherein said recesses between said projections have a dimension to enable a volume of liquid to flow between said projections sufficient to prevent said gel slab from adhering to said side walls.

69. The container of claim 66, wherein said projections are arranged in a substantially uniform array.

70. The container of claim 69, wherein said projections have a substantially pyramid shape.

71. A method of staining an electrophoresis gel in a staining assembly, comprising the steps of:
providing a holding tank for holding a plurality of electrophoresis gels;
providing at least one staining tank for staining said electrophoresis gels;
providing a computer controlled robotic assembly for manipulating said electrophoresis gels;
sequentially transferring said electrophoresis gels to said at least one staining tank for a time sufficient to stain said electrophoresis gels; and
transferring said electrophoresis gels from said at least one staining tank to said holding tank.

72. The method of claim 71, wherein said staining assembly comprises a plurality of staining tanks containing a reagent, and wherein said method comprises sequentially transferring said electrophoresis gels through said staining tanks.

73. The method of claim 72, wherein said staining assembly comprises an imaging tank having an imaging device, and wherein said method further comprises transferring said electrophoresis gels from said staining tanks to said imaging tank and capturing an image of said electrophoresis gel.

74. The method of claim 73, wherein said staining assembly further comprises at least one rinse tank, and said method comprises the step of transferring said electrophoresis gels from said staining tanks to said rinse tank for a time sufficient to rinse reagents from said electrophoresis gel and thereafter transferring said electrophoresis gel to said imaging tank.

75. The method of claim 74, comprising the step of transferring said electrophoresis gel from said imaging tank to a respective staining tank after capturing said image.

76. The method of claim 74, wherein said imaging tank includes a transparent side wall and an agitator, said method comprising moving said agitator to press said electrophoresis gel against said transparent side wall and thereafter capturing said image.
